(19) United States
(12) Patent Application Publication
(10) Pub. No.: US 2022/0169884 A1
(43) Pub. Date: Jun. 2, 2022

(54) CURABLE COMPOSITION, CURED COMPOSITION, AND ABRASION-RESISTANT ARTICLE

(71) Applicant: 3M INNOVATIVE PROPERTIES COMPANY, St. Paul, MN (US)

(72) Inventors: Chunjie Zhang, Shoreview, MN (US); Jung-Sheng Wu, Woodbury, MN (US); Thomas P. Klun, Lakeland, MN (US); Richard J. Pokorny, Maplewood, MN (US); Benjamin R. Coonce, South St. Paul, MN (US)

(21) Appl. No.: 17/436,952

(22) PCT Filed: Apr. 8, 2020
(86) PCT No.: PCT/IB2020/053356

§ 371 Date: Sep. 7, 2021

Related U.S. Application Data
(60) Provisional application No. 62/832,485, filed on Apr. 11, 2019.

(51) Int. Cl. C09D 133/14; C08F 220/28; C08K 3/22; C09D 7/61; C09D 7/40; C09D 4/00

(52) U.S. Cl. CPC C09D 133/14; C08F 220/283; C08K 3/22; C09D 7/61; C08K 2201/011; C09D 4/00; C08K 2003/2227; C08K 2201/005; C09D 7/67

(57) ABSTRACT

A curable composition comprising components: a) alpha-alumina particles; b) 4-(2-(acryloyloxy)ethoxy)-4-oxobutanoic acid; c) at least one free-radically polymerizable compound different from component b); and d) optionally an effective amount of free-radical initiator. An at least partially cured reaction product of components comprising components a) to d), and an abrasion-resistant article including the same are also disclosed.

### TECHNICAL FIELD

The present disclosure broadly relates to free-radical curable/cured compositions and articles that include them.

### BACKGROUND

Mineral particles are commonly added to curable resins to improve toughness and/or hardness of the resultant cured resin.

A multitude of protective coatings have been developed over the years. Some examples include paints, automotive clearcoats, paints and lacquers, floor finishes, sealers (e.g., waterproof coatings), and abrasion-resistant optical coatings.

Some types of abrasion-resistant protective coatings contain reinforcing particles (e.g., inorganic particles) that impart improved abrasion resistance to the coatings. However, the performance of such protective coatings remains an ongoing issue, and there remains a need for protective coating having superior abrasion resistance.

### SUMMARY

The present disclosure provides curable compositions suitable for use as protective coatings. In some embodiments, the curable compositions can be coated and cured to provide abrasion-resistant transparent protective coatings.

In one aspect, the present disclosure provides a curable composition comprising components:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

In another aspect, the present disclosure provides an at least partially cured reaction product of components comprising:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

In yet another aspect, the present disclosure provides an abrasion-resistant article comprising a substrate having a protective layer disposed on at least a portion thereof, wherein the protective layer comprises a reaction product of components comprising:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

As used herein:

The term “D_{V}50” refers to that particle diameter at which 50 percent by volume of the particles in a distribution of particles have that diameter or a smaller diameter.

The term “D_{V}90” refers to that particle diameter at which 90 percent by volume of the particles in a distribution of particles have that diameter or a smaller diameter.

In the case of alumina particles referred to in the present disclosure, particle size (e.g., 10 nanometers to 5 millimeters) may be determined by any suitable technique such as, for example, laser diffraction (e.g., using a Horiba LA-960 particle size analyzer according to ISO 13320:2009 “Particle size analysis—Laser diffraction methods”, International Organization for Standardization, Geneva, Switzerland.

The prefix “(meth)acryl” means “acryl” and/or “methacryl”.

The term “particle diameter” refers to the diameter of spherical particles, and the average particle diameter for non-spherical particles.

The term “particle size” refers to particle diameter.

Features and advantages of the present disclosure will be further understood upon consideration of the detailed description as well as the appended claims.

### BRIEF DESCRIPTION OF THE DRAWINGS

FIG. 1 is a schematic side view of an exemplary abrasion-resistant article 100 according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Curable compositions according to the present disclosure comprise components:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

### Component a

The alpha-alumina particles contain a majority of alumina in its alpha crystalline form, although minor amounts of other materials may also be present (e.g., seed crystals and/or grain size modifiers as well as other crystalline phases). Preferably the alpha-alumina particles consist essentially of (e.g., are at least 99 weight percent), or even consist of, alpha-alumina.

Any particle size of alpha-alumina particles may be used. Alpha-alumina particles can be readily purchased in many size grades from commercial suppliers (e.g., Sasol North America, Houston, Tex. and Washington Mills, Tonawanda, N.Y.), and can be sized according to known methods (e.g., using sieves and/or air classification techniques). Smaller sizes of alpha-alumina particles can be made by milling larger size alpha-alumina, for example, using a ball mill or a jet mill. If using a ball mill the milling media preferably comprises, or even consists of, alpha-alumina, although other milling media such as, for example, aluminum zirconate media may be used. Alpha-alumina can be readily obtained from commercial suppliers in a wide variety of particle sizes. Alpha-alumina particles, which may even be in the size range of having particle size distribution with a D_{V}50 of from 0.01 to 1 micron, can be readily obtained from commercial sources. Suppliers include US Research Nanomaterials, Inc., Houston, Tex.; Sisco Research Laboratories Pvt. Ltd., Mumbai, India; and Baikowski International Corp., Charlotte, N.C.

The alpha-alumina particles may have any particle size (e.g., having a particle size distribution with a D_{V}50 from 0.01 micron to 1 millimeter). In some embodiments, the alpha-alumina particles are micrometer-scale alpha-alumina particles having a particle size distribution with a D_{V}50 of from 0.01 to 1 micron. In some preferred embodiments, the alpha-alumina particles have a particle size distribution with a D_{V}50 of 0.15 to 1 micron, or 0.2 to 0.3 micron. In some preferred embodiments, the alpha-alumina particles have a particle size distribution with a D_{V}50 of at least 0.01 micron, at least 0.05 micron, at least 0.1 micron, at least 0.21 micron, at least 0.23 micron, at least 0.25 micron, at least 0.30 micron, at least 0.40 micron, or at least 0.50 micron up to 1 micron, 3 microns, 5 microns, 10 microns, 30 microns, 50 microns, or even 100 microns. In some embodiments, the alpha-alumina particles have a volume average particle diameter D_{V}50 of less than or equal to 100 nanometers. In some embodiments, the alpha-alumina particles have a volume average particle diameter D_{V}50 of greater than or equal to 100 nanometers. In some preferred embodiments, the alpha-alumina particles have a polymodal distribution.

The alumina particles may be included in the curable composition in any suitable amount. In some embodiments, the alpha-alumina particles comprise 0.01 to 20 weight percent, 2 to 10 weight percent, or 2 to 7 weight percent based on the total weight of components a) to c). In some embodiments, the curable composition contains from 0.2 to 9 weight percent (preferably 0.2 to 3 weight percent) of alpha-alumina particles (i.e., component a) based on the total weight of components a) to c). In some embodiments, the alpha-alumina particles comprise 20 to 70 weight percent, 30 to 70 weight percent, or 40 to 70 weight percent based on the total weight of components a) to c).

In some preferred embodiments, the curable composition contains less than 8, 7, 6, 5, 4, 3, or even less than 2 weight percent of alpha-alumina particles having a particle size distribution with a D_{V}50 of from 0.05 to 0.3 micron, based on the total weight of components a) to c).

### Component b

4-(2-(Acryloyloxy)ethoxy)-4-oxobutanoic acid, CAS No. 50940-49-3, has the chemical structure:

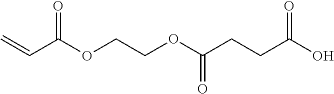

It is readily available from commercial sources such as, for example, Tokyo Chemical Industry, Ltd. (TCI, Tokyo, Japan) and Spectrum Chemical Mfg. Corp., New Brunswick, N.J. It can also be made according to known methods.

The 4-(2-(acryloyloxy)ethoxy)-4-oxobutanoic acid can be included in the curable composition in any suitable amount. In some preferred embodiments, it is added in an amount of from 0.01 to 30 weight percent, more preferably from 0.1 to 20 weight percent, and even more preferably from 0.1 to 10 weight percent, based on the total weight of components a) to c), although other amounts may also be used.

Without wishing to be bound be theory, the present inventors believe that 4-(2-(acryloyloxy)ethoxy)-4-oxobutanoic acid serves as a coupling agent between the alpha-alumina particles and the polymerized reaction product after free-radical polymerization of the curable composition.

### Component c

Useful free-radically polymerizable compounds may have a free-radically polymerizable group (e.g., (meth)acrylate) functionality of 1 to 2, or even more if desired. These monomers may function as diluents or solvents, as viscosity reducers, as binders when cured, and as crosslinking agents, for example. Examples of useful free-radically polymerizable compounds include styrenes; divinylbenzene; propylene; butylene; hexene; maleates; and (meth)acrylates such as, e.g., octyl (meth)acrylate, nonylphenol ethoxylate (meth)acrylate, isononyl (meth)acrylate, isobornyl (meth)acrylate, 2-(2-ethoxyethoxy)ethyl (meth)acrylate, 2-ethylhexyl (meth)acrylate, lauryl (meth)acrylate, beta-carboxyethyl (meth)acrylate, isobutyl (meth)acrylate, 2-hydroxyethyl (meth)acrylate, isodecyl (meth)acrylate, dodecyl (meth)acrylate, n-butyl (meth)acrylate, methyl (meth)acrylate, hexyl (meth)acrylate, (meth)acrylic acid, stearyl (meth)acrylate, hydroxy functional caprolactone ester (meth)acrylate, isooctyl (meth)acrylate, hydroxymethyl (meth)acrylate, hydroxypropyl (meth)acrylate, hydroxyisopropyl (meth)acrylate, hydroxybutyl(meth)acrylate, hydroxyisobutyl (meth)acrylate, tetrahydrofurfuryl (meth)acrylate, and alkoxylated versions of the above (meth(acrylate monomers, such as alkoxylated tetrahydrofurfuryl (meth)acrylate; di(meth)acrylates such as 1,6-hexanediol di(meth)acrylate, poly(ethylene glycol) di(meth)acrylates, polybutadiene di(meth)acrylates, polyurethane di(meth)acrylates, ethylene glycol di(meth)acrylate, hexanediol di(meth)acrylate, diethylene glycol di(meth)acrylate, triethylene glycol di(meth)acrylate, tetraethylene glycol di(meth)acrylate, neopentyl glycol di(meth)acrylate, alkoxylated versions of the above di(meth)acrylates, and combinations thereof. Of these, 1,6-hexanediol diacrylate is preferred in some embodiments. (Meth)acrylate monomers having a functionality of 1 or 2 (e.g., as listed above) are widely commercially available, for example, from Sartomer Co., Exton, Pa.

Useful free-radically polymerizable compounds may have a free-radically polymerizable group functionality of greater than 2. Examples of suitable monomers include trimethylolpropane tri(meth)acrylate, pentaerythritol tri(meth)acrylate, pentaerythritol tetra(meth)acrylate, and dipentaerythritol hexa(meth)acrylate.

Exemplary useful free-radically polymerizable compounds also include mono- and polyfunctional silicone (meth)acrylates. Of these, silicone poly(meth)acrylates may be preferred because the likelihood of unbound silicone (meth)acrylate after curing is generally reduced. Exemplary silicone (meth)acrylates include EBECRYL 350 silicone diacrylate and EBECRYL 1360 silicone hexaacrylate from Allnex, CN9800 aliphatic silicone acrylate and CN990 siliconized urethane acrylate compound from Sartomer Co., and TEGO RAD 2100, TEGO RAD 2250, and TEGO RAD 2500 silicone polyether acrylate from Evonik Industries, Parsippany, N.J.

Exemplary useful free-radically polymerizable compounds also include urethane (meth)acrylate oligomers such as, for example, urethane (meth)acrylate compounds having an average (meth)acrylate functionality of 3 to 9. Examples of commercially available urethane (meth)acrylate oligomers include those available from Sartomer Co., Exton, Pa. as N3D-F130, N3D-I150, M-CURE 203, CN9302, CN9004, CN9005, CN9006, CN9007, CN9023, CN9028, CN9178, CN9290US, CN986, CN989, CN9893, CN996, CN2920, CN3211, CN9001, CN9009, CN9010, CN959, CN9011, CN9062, CN9071, CN9014, CN9070, CN929, CN945A70, CN9025, CN9026, CN962, CN964, CN965, CN968, CN969, CN980, CN981, CN983, CN991, CN2921, CN981B88, CN985B88, CN963B80, CN982B88, CN961H81, CN966H90, CN963A80, CN964A85, CN982A75, CN963E80, CN963J85, CN966J7, CN9013, CN9018, CN9024, CN9030, CN9031, CN9032, CN9039, CN9102, CN9167US, CN9782, CN9783, CN992, CN902J75, CN975, CN972, CN973H85, N970A60, CN971A80, CN973A80, CN970E60, CN973J75, CN971J75, CN9072, CN9014, CN9070, CN966H90, CN966J75, CN9018, CN990, CN1964, CN1963, CN9788, and SARBIO 7402; and those available from Allnex, Frankfurt, Germany, as EBECRYL 220, EBECRYL 221, EBECRYL 230, EBECRYL 246, EBECRYL 271, EBECRYL 1290, EBECRYL 1291, EBECRYL 4100, EBECRYL 4101, EBECRYL 4200, EBECRYL 4201, EBECRYL 4265, EBECRYL 4500, EBECRYL 4587, EBECRYL 4654, EBECRYL 4666, EBECRYL 4738, EBECRYL 4740, EBECRYL 4858, EBECRYL 4859, EBECRYL 5129, EBECRYL 8210, EBECRYL 8296, EBECRYL 8301-R, EBECRYL 8402, EBECRYL 8415, EBECRYL 8465, EBECRYL 8602, EBECRYL 8604, EBECRYL 8702, EBECRYL 8804, EBECRYL 8807, EBECRYL 8810, and EBECRYL 8811.

Combinations of free-radically polymerizable compounds can also be used. In such cases, adjusting the stoichiometry may lead to non-integral (fractional) average free-radically polymerizable group functionality (e.g., 1.5, 1.7, 2.25, 2.5).

The at least one free-radically polymerizable compound can be included in the curable composition in any suitable amount. In some preferred embodiments, it is added in an amount of from 10 to 99 weight percent, more preferably from 50 to 98 weight percent, and even more preferably from 80 to 96 weight percent, based on the total weight of components a) to c), although other amounts may also be used.

### Optional Component d

At least one free-radical initiator is optionally, but preferably, added (typically in an effective amount) to the curable composition to facilitate polymerization. The free-radical initiator may be a free-radical thermal initiator (i.e., thermally activated) and/or a free-radical photoinitiator (i.e., activated by absorption of electromagnetic radiation). In instances wherein component d) is not included, energy (e.g., electron beam radiation and/or heating) should be supplied to cause free-radical polymerization of the curable composition.

By the term “effective amount” is meant an amount that is at least sufficient amount to cause curing of the curable composition under polymerization conditions. Typically, the total amount of initiator (both photoinitiator and thermal initiator) is used in amounts ranging from 0.1 to 10 percent by weight (preferably 1 to 5 percent by weight), based on the total weight of the curable composition, although this is not a requirement.

It will be recognized that curing may be complete even though polymerizable (meth)acrylate groups remain.

Exemplary thermal initiators include organic peroxides (e.g., diacyl peroxides, peroxy ketals, ketone peroxides, hydroperoxides, dialkyl peroxides, peroxy esters, and peroxydicarbonates), azo compounds (e.g., azobis(isobutyronitrile)).

Examples of free-radical photoinitiators include 2-benzyl-2-(dimethylamino)-4′-morpholino-butyrophenone; 1-hydroxycyclohexyl-phenyl ketone; 2-methyl-144-(methylthio)phenyl1-2-morpholino-propan-1-one; 4-methylbenzophenone; 4-phenylbenzophenone; 2-hydroxy-2-methyl-1- phenylpropanone; 1-[4-(2-hydroxyethoxyl)-phenyl]-2-hydroxy-2-methylpropanone; 2,2-dimethoxy-2-phenylacetophenone; 4-(4-methylphenylthio)benzophenone; benzophenone; 2,4-diethylthioxanthone; 4,4′-bis(diethylamino)-benzophenone; 2-isopropylthioxanthone; acylphosphine oxide derivatives, acylphosphinate derivatives, and acylphosphine derivatives (e.g., phenylbis(2,4,6-trimethylbenzoyl)phosphine oxide (available as OMNIRAD 819 from IGM Resins, St. Charles, Illinois), phenylbis(2,4,6-trimethylbenzoyl)phosphine (e.g., as available as OMNIRAD 2100 from IGM Resins), bis(2,4,6-trimethylbenzoyl)phenylphosphine oxide, 2,4,6-trimethylbenzoyldiphenylphosphine oxide (e.g., as available as OMNIRAD 8953X from IGM Resins), isopropoxyphenyl-2,4,6-trimethylbenzoylphosphine oxide, dimethyl pivaloylphosphonate), ethyl (2,4,6-trimethylbenzoyl) phenyl phosphinate (e.g., as available as OMNIRAD TPO-L from IGM Resins); bis(cyclopentadienyl) bis[2,6-difluoro-3-(1-pyrryl)phenyl]titanium (e.g., as available as OMNIRAD 784 from IGM Resins); and combinations thereof.

The curable composition is curable by free-radical polymerization of the free-radically polymerizable groups in components b) and c). During this process, some or all of optional component d) is typically decomposed, and some or all of components b) and c) are copolymerized to form a polymer matrix containing the alpha-alumina particles. Free-radically polymerization can be initiated using heat and/or actinic (e.g., ultraviolet and/or visible) electromagnetic radiation.

If desired, the curable composition and/or its corresponding cured reaction product may contain additional components such as, for example, fillers, thickeners, thixotropes, fragrances, antioxidants, surfactants, and UV stabilizers.

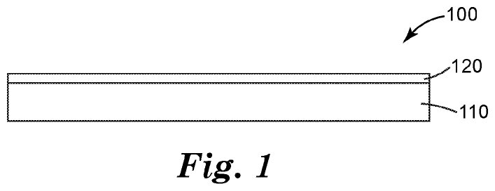

Curable compositions according to the present disclosure may be disposed on a substrate and at least partially cured to form an at least partially cured reaction product according to the present disclosure that can act as an abrasion-resistant layer of an abrasion-resistant article. Referring now to FIG. 1, abrasion-resistant article 100 comprises abrasion-resistant layer 120 disposed on substrate 110.

Examples of a suitable substrate include substrates made of metal, semiconductors, glass, ceramic (including porous ceramic), glass ceramic, plastic, wood, paper, building materials, and inorganic-organic composite materials. The substrates may be pretreated, for example, by a corona treatment or with a preliminary coating such as a lacquer coating (lacquered surfaces), an enamel coating, a paint coating or a metalized surface, or by impregnation.

Examples of metal substrates include, for example, copper, aluminum, brass, iron, steel and zinc. Examples of semiconductors are silicon, for example in the form of wafers, and indium tin oxide layers (ITO layers) on glass. The glass used may be any conventional glass types, for example silica glass, borosilicate glass or soda-lime silicate glass. Examples of plastic substrates are polycarbonate, polymethyl methacrylate, polyacrylates, polyethylene terephthalate. Especially for optical or optoelectronic applications, transparent substrates are suitable, for example of glass or plastic. Examples of building materials are stones, concrete, tiles, plasterboard or bricks. Exemplary suitable substrates include polymer films, optical elements (e.g., lenses, prisms, mirrors, beam splitters, and display covers), walls, and molded polymeric articles.

The curable composition may be applied to the substrate in any customary manner. It is possible to use all common coating processes. Examples include, spraying, wiping, spin-coating, (electro) dip-coating, knife-coating, squirting, casting, painting, flow-coating, knife-casting, slot-coating, meniscus-coating, curtain-coating, and roller application.

### Select Embodiments of the Present Disclosure

In a first embodiment, the present disclosure provides a curable composition comprising components:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

In a second embodiment, the present disclosure provides a curable composition according to the first embodiment, wherein the at least one free-radically polymerizable compound comprises at least one (meth)acrylic monomer.

In a third embodiment, the present disclosure provides a curable composition according to the first or second embodiment, wherein the alpha-alumina particles have a volume average particle diameter of less than or equal to 100 nanometers.

In a fourth embodiment, the present disclosure provides a curable composition according to the first or second embodiment, wherein the alpha-alumina particles have a volume average particle diameter of greater than 100 nanometers.

In a fifth embodiment, the present disclosure provides a curable composition according to any one of the first to fourth embodiments, wherein the alpha-alumina particles comprise 2 to 20 percent by weight, based on the total weight of components a) to c).

In a sixth embodiment, the present disclosure provides an at least partially cured reaction (preferably cured) product of components comprising:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

In a seventh embodiment, the present disclosure provides a cured reaction product according to the sixth embodiment, wherein the at least one free-radically polymerizable compound comprises at least one (meth)acrylic monomer.

In an eighth embodiment, the present disclosure provides a cured reaction product according to the sixth or seventh embodiment, wherein the alpha-alumina particles have a volume average particle diameter of less than or equal to 100 nanometers.

In a ninth embodiment, the present disclosure provides a cured reaction product according to the sixth or seventh embodiment, wherein the alpha-alumina particles have a volume average particle diameter of greater than 100 nanometers.

In a tenth embodiment, the present disclosure provides a cured reaction product according to any one of the sixth to ninth embodiments, wherein the alpha-alumina particles comprise from 2 to 20 percent by weight, based on the total weight of components a) to c).

In an eleventh embodiment, the present disclosure provides an abrasion-resistant article comprising a substrate having a protective layer disposed on at least a portion thereof, wherein the protective layer comprises a reaction product of components comprising:

a) alpha-alumina particles;

b) 4-(2-(acryloyloxy)ethoxy)-4-oxobutanoic acid;

c) at least one free-radically polymerizable compound different from component b); and

d) optionally an effective amount of free-radical initiator.

In a twelfth embodiment, the present disclosure provides an abrasion-resistant article according to the eleventh embodiment, wherein the at least one free-radically polymerizable compound comprises at least one (meth)acrylic monomer.

In a thirteenth embodiment, the present disclosure provides an abrasion-resistant article according to the eleventh or twelfth embodiment, wherein the alpha-alumina particles have a volume average particle diameter of less than or equal to 100 nanometers.

In a fourteenth embodiment, the present disclosure provides an abrasion-resistant article according to the eleventh or twelfth embodiment, wherein the alpha-alumina particles have a volume average particle diameter of greater than 100 nanometers.

In a fifteenth embodiment, the present disclosure provides an abrasion-resistant article according to any one of the eleventh to fourteenth embodiments, wherein the alpha-alumina particles comprise 2 to 20 percent by weight, based on the total weight of components a) to c).

In a sixteenth embodiment, the present disclosure provides an abrasion-resistant article according to any one of the eleventh to fifteenth embodiments, wherein the substrate comprises a lens element.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. In the Tables, the phrase “Std Dev” means Standard Deviation.

Table 1, below, lists abbreviations and materials used in the Examples section.

TABLE 1

| DESIGNATION | DESCRIPTION |
|---|---|
| MEK | methyl ethyl ketone |
| MP | 1-methoxy-2-propanol |
| PC film | bisphenol A-based polycarbonate film, 5 mil |
| | (0.13 mm) thick, available as LEXAN 8010- |
| | 112MC film from Sabic Innovative Plastics, |
| | Riyadh, Saudi Arabia |
| PI1 | difunctional alpha-hydroxyketone photoinitiator, |
| | available as ESACURE ONE from IGM Resins, |
| | Charlotte, North Carolina |
| SR611 | alkoxylated tetrahydrofurfuryl acrylate monomer |
| | from Sartomer Co., Exton, Pennsylvania |
| HFPO-Urethane | DES N100/0.95 PET3A/0.10 |
| | HFPO—C(═O)NHCH₂CH₂OH (HFPO-1) in |
| | col. 15, lines 14-34 of U.S. Pat. No. 8,728,623 |
| | (Pokorny et al.) |
| TEG2100 | TEGORAD 2100 silicone acrylate, obtained |
| | from Evonik Industries, Essen, Germany |
| AANP | Alpha-Alumina Nano Powder, 99.99% purity, |
| | obtained as 26N-0811UPA from Inframat |
| | Advanced Materials, Manchester, Connecticut |
| A174 Silane | 3-(trimethoxysilyl)propyl methacrylate, available |
| | from Millipore Sigma, Burlington, Massachusetts |
| HEMA-SA | 2-(methacryloyloxy)ethyl succinate, i.e. (4-(2- |
| | (methacryloyloxy)ethoxy)-4-oxobutanoic acid), |
| | available from Sigma-Adrich |
| HEMA-PO4 | 2-(methacryloyloxy)ethyl phosphate, available |
| | from Polysciences, Inc. |
| HEA-SA | mono-2-(acryloyloxy)ethyl succinate, i.e. (4-(2- |
| | (acryloyloxy)ethoxy)-4-oxobutanoic acid), |
| | available from TCI America |
| HEA-PO4 | phosphoric acid 2-hydroxyethyl acrylate ester, |
| | available from Sigma-Aldrich |
| K90 Silane | Preparative Example 7 of U.S. Pat. No. 9,790,396 |
| | B2 (Klun et al.), col. 22, lines 9-20. |
| AA | Acrylic acid, available from Sigma-Aldrich |
| MA | Methacrylic acid, available from Sigma-Aldrich |
| 1427 | Urethane acrylate oligomer prepared as described |
| | hereinbelow |
| W9012 | Solvent-free wetting and dispersing additive, |
| | available as BYK-W 9012 from BYK USA, |
| | Wallingford, Connecticut |
| D540 | 100% active polymeric dispersant, available as |
| | SOLPLUS D540 from Lubrizol Corp., |
| | Brecksville, Ohio |

### Preparation of Urethane Acrylate Oligomer (1427)

A 250-mL jar equipped with a magnetic stir bar was charged with 39.76 g (0.2082 eq.) of DESMODUR N100 biuret-based hexamethylene diisocyanate oligomer (obtained from Covestro LLC, Pittsburgh, Pa.), 25 g of MEK, 12.33 g (0.1062 eq.) of 2-hydroxyethyl acrylate (Alfa Aesar, Ward Hill, Mass.), 47.91 g (0.1062 eq.) of pentaerythritol triacrylate (obtained as SR444C from Sartomer Co., Exton, Pa.), for a total of 1.01 eq. OH per eq. of NCO, 0.025 g (250 ppm) 2,6-di-t-butyl-4-methylphenol (BHT, Aldrich Chemical Co., Milwaukee, Wis.), 0.005 g (50 ppm) of 4-hydroxy-2,2,6,6-tetramethylpiperidine-l-oxyl (4-hydroxy TEMPO, Aldrich Chemical Co.) and 0.05 g (500 ppm) of dibutyltin dilaurate (Aldrich Chemical Co.). The jar was placed in a water bath at room temperature and allowed to stir for 10 min. After 10 min., it was placed into a 55° C. bath for 4 hr. At the end of that time, the reaction mixture was monitored by FTIR and found to have no NCO peak at 2265 cm⁻¹. The resulting material was 80 weight percent solids, and had a molecular average acrylate functionality of 7.2.

### Eraser Abrasion Test

Abrasion of film samples was tested downweb to the coating direction using a Taber model 5750 Linear Abraser (Taber Industries, North Tonawanda, N.Y.). The collet oscillated at 40 cycles/minute and the length of stroke was 2 inches (5.1 cm). The abrasive material used for this test was an eraser insert (from Summers Optical, a division of EMS Acquisition Corp., Hatfield, Pa.). The eraser insert had a diameter of 6.5 mm and met the requirements of military standard Mil-E-12397B.

The eraser insert was held in place through duration of test by the collet. One sample was tested on three different spots for each example with a weight of 1.1 kg weight and 20 cycles. After abrasion, the sample was cleaned by wiping with a lens cleaning towelette (Radnor Products, Radnor, Pa.). The optical haze and transmission of each sample was measured using a Haze-Gard Plus haze meter (BYK Gardner, Columbia, Md.) at the three different spots. The reported values of haze and transmission are the average of the values obtained on the three different spots. The delta haze value for each sample was calculated by subtracting the haze of an untested region of the sample. The loss of transmission for each sample was calculated by subtracting the transmission of an untested region of the sample from the transmission of a tested region.

### Preparation of Alpha-Alumina Nanoparticles (AANP1)

An alpha-alumina nanoparticle dispersion was made by a media milling process. 180 g of MEK, 180 g of W9012 dispersing additive, and 181 g of AANP were mixed together using a Dispermat CN-10 laboratory high-shear disperser (BYK-Gardner USA, Columbia, Md.). The mixed dispersion was milled in a MiniCer laboratory media mill (Netzsch, Exton, Pa.) with 0.2 mm yttria-stabilized zirconia milling media. Aliquots (0.2 mL) were sampled every hour for 8 hours. Each aliquot was diluted with 2 mL of MEK prior to particle size analysis by laser diffraction, which was performed using a Horiba LA-960 laser particle size analyzer. The resultant alpha-alumina nanoparticle dispersion had 54 wt. % total solids and an alpha-alumina content of 27 wt. %, a median particle diameter of 0.067 microns, a D_{V}50 of 0.0672 (Std Dev=0.009) microns, and a D_{V}90 of 0.0796 microns.

### Preparation of Alpha-Alumina Nanoparticles (AANP2)

The alpha-alumina nanoparticle dispersion was made through a media milling process in which 243.1 g of MEK, 60 g of D540 dispersing additive (Lubrizol), and 240.3 g of AANP were mixed together using a Dispermat CN-10 laboratory high-shear disperser (BYK-Gardner USA, Columbia, Md.). The mixed dispersion was milled in MiniCer laboratory media mill (Netzsch, Exton, Pa.) with 0.2 mm yttria stabilized zirconia milling media. Aliquots were sampled every hour up to 6 hours. 0.2 mL of aliquot was diluted with 2 mL of MEK prior to particle size analysis by laser diffraction, which was performed on Horiba LA-960. D_{V}50=0.159 microns. The slurry after milling had 44.81 wt. % total solids with 35.85 wt. % of alpha alumina.

### Master Formulation A

Master Formulation A was prepared by mixing the components reported in Table 2, below.

TABLE 2
MASTER FORMULATION A

| | QUANTITY, |
|---|---|
| COMPONENT | g |
| 1427 | 34.80 |
| TEG2100 | 0.32 |
| PI1 | 0.64 |
| ethanol | 48.00 |
| MP | 6.00 |

### Comparative Examples A1-A8

AANP1 was used to make the following formulations (Table 3). Comparative Example A1 did not contain alpha-alumina nanoparticles. The formulations were hand-coated on PC film using a #12 wire-wound rod (RD Specialties, Webster, N.Y., 0.30 mm wire size). The coated PC films were allowed to dry at room temperature first and then dried at 80 ° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). In Table 3 (below), all examples contained 4.5 g of Master Formulation A and 0.25 g of SR611 (diluted to 32 wt. % with ethanol), and they had a total solids content of 32.1 percent.

TABLE 3

| | | | EFFECTIVE AANP1 |
|---|---|---|---|
| COMPARATIVE | AANP1, | ETHANOL, | SOLIDS, |
| EXAMPLE | g | g | % of Total Solids |
| A1 | 0.000 | 0.00 | 0.0 |
| A2 | 0.035 | 0.02 | 0.6 |
| A3 | 0.072 | 0.05 | 1.2 |
| A4 | 0.150 | 0.10 | 2.5 |
| A5 | 0.315 | 0.21 | 5.0 |
| A6 | 0.710 | 0.48 | 10.0 |
| A7 | 1.210 | 0.82 | 15.0 |
| A8 | 1.880 | 1.27 | 20.0 |

TABLE 4

| | BEFORE ERASER | | AFTER ERASER | | | |
|---|---|---|---|---|---|---|
| | ABRASION | | ABRASION | | | |
| | % | | % | | Δ (After-Before) | |
| COMPARATIVE | Transmission | % Haze | Transmission | % Haze | Δ % | Δ % |
| EXAMPLE | (Std Dev) | (Std Dev) | (Std Dev) | (Std Dev) | Transmission | Haze |
| A1 | 91.4 | 0.16 | 91.2 | 7.05 | −0.2 | 6.89 |
| | (0.00) | (0.06) | (0.00) | (0.31) | | |
| A2 | 91.4 | 0.16 | 91.3 | 5.89 | −0.1 | 5.73 |
| | (0.06) | (0.03) | (0.08) | (0.88) | | |
| A3 | 91.1 | 0.23 | 91.4 | 5.47 | 0.3 | 5.24 |
| | (0.00) | (0.00) | (0.06) | (0.65) | | |
| A4 | 90.7 | 0.58 | 91.3 | 3.80 | 0.6 | 3.22 |
| | (0.06) | (0.09) | (0.00) | (0.80) | | |
| A5 | 90.2 | 1.77 | 91.0 | 4.85 | 0.8 | 3.08 |
| | (0.00) | (0.06) | (0.06) | (0.84) | | |
| A6 | 89.4 | 5.43 | 90.5 | 9.64 | 1.1 | 4.21 |
| | (0.10) | (0.21) | (0.12) | (0.21) | | |
| A7 | 88.9 | 11.5 | 90.0 | 14.6 | 1.1 | 3.10 |
| | (0.00) | (0.25) | (0.06) | (0.25) | | |
| A8 | 88.7 | 15.4 | 89.5 | 19.6 | 0.8 | 4.20 |
| | (0.06) | (0.61) | (0.06) | (0.26) | | |

### Preparation Of Alpha-Alumina Dispersions DISP1-DISP9

AANP1 was treated with surface-modifying agent in MEK with stirring for 24 hours before it was added to coating formulations as reported in Table 5. The alpha-alumina nanoparticle dispersion had a total percent solids of 54.0 wt. % including 27.0 wt. % of alpha-alumina nanoparticles and 27.0 wt. % W9012 dispersant, prior to adding surface-modifying agent. Dispersions in Table 5 (below) were 27.0 wt. % included 1.4 grams of alpha-alumina nanoparticles (AANP1) and 406.3 micromoles of the specified surface-modifying agent.

TABLE 5

| SURFACE- | | |
|---|---|---|
| MODIFIED | SURFACE- | WEIGHT OF SURFACE- |
| ALUMINA | MODIFYING | MODIFYING AGENT, |
| DISPERSION | AGENT | g |
| DISP1 | None | 0 |
| DISP2 | A174 Silane | 0.101 |
| DISP3 | HEMA-SA | 0.094 |
| DISP4 | HEMA-PO4 | 0.085 |
| DISP5 | HEA-SA | 0.088 |
| DISP6 | HEA-PO4 | 0.08 |
| DISP7 | K90 Silane | 0.087 |
| DISP8 | AA | 0.029 |
| DISP9 | MA | 0.035 |

### Examples 1-2 and Comparative Examples D1-K2

Coating formulations containing surface modified alpha-alumina nanoparticles are reported in Table 6. The formulations were hand-coated on PC film using a #12 wire-wound rod (RD Specialties, 0.30 mm wire size). The coated PC films were allowed to dry at room temperature first and then dried at 80° C. in an oven for 1 min. The dried samples were cured using a UV processor equipped with an H-type bulb (500 W, Heraeus Noblelight America/Fusion UV Systems) at 100% power under nitrogen purge at 30 feet/min (9.1 m/min). In Table 6 (below), all examples included 4.50 g of Master Formulation A and 0.25 g of SR611 (32 wt. % in ethanol), and had a total solids content of 32.1 wt. %.

TABLE 6

| | | | | EFFECTIVE |
|---|---|---|---|---|
| | SURFACE- | | | PARTICLE |
| | MODIFIED | ALUMINA | | WT. % |
| | ALUMINA | DIS- | ETHA- | BASED |
| | DIS- | PERSION, | NOL, | ON TOTAL |
| EXAMPLE | PERSION | g | g | SOLIDS |
| COMPARATIVE | DISP1 | 0.000 | 0.00 | 0.0 |
| EXAMPLE D1 | | | | |
| COMPARATIVE | | 0.072 | 0.05 | 1.2 |
| EXAMPLE D2 | | | | |
| COMPARATIVE | | 0.150 | 0.10 | 2.5 |
| EXAMPLE D3 | | | | |
| COMPARATIVE | DISP2 | 0.071 | 0.05 | 1.2 |
| EXAMPLE E1 | | | | |
| COMPARATIVE | | 0.145 | 0.10 | 2.4 |
| EXAMPLE E2 | | | | |
| COMPARATIVE | DISP3 | 0.071 | 0.05 | 1.2 |
| EXAMPLE F1 | | | | |
| COMPARATIVE | | 0.145 | 0.10 | 2.4 |
| EXAMPLE F2 | | | | |
| COMPARATIVE | DISP4 | 0.071 | 0.05 | 1.2 |
| EXAMPLE G1 | | | | |
| COMPARATIVE | | 0.145 | 0.10 | 2.4 |
| EXAMPLE G2 | | | | |
| 1 | DISP5 | 0.071 | 0.05 | 1.2 |
| 2 | | 0.145 | 0.10 | 2.4 |
| COMPARATIVE | DISP6 | 0.071 | 0.05 | 1.2 |
| EXAMPLE H1 | | | | |
| COMPARATIVE | | 0.145 | 0.10 | 2.4 |
| EXAMPLE H2 | | | | |
| COMPARATIVE | DISP7 | 0.071 | 0.05 | 1.2 |
| EXAMPLE I1 | | | | |
| COMPARATIVE | | 0.145 | 0.10 | 2.4 |
| EXAMPLE 12 | | | | |
| COMPARATIVE | DISP8 | 0.071 | 0.05 | 1.2 |
| EXAMPLE J1 | | | | |
| COMPARATIVE | | 0.148 | 0.10 | 2.5 |
| EXAMPLE J2 | | | | |
| COMPARATIVE | DISP9 | 0.071 | 0.05 | 1.2 |
| EXAMPLE K1 | | | | |
| COMPARATIVE | | 0.148 | 0.10 | 2.5 |
| EXAMPLE K2 | | | | |

The transmission and haze before and after the eraser abrasion test are reported in Table 7, below.

TABLE 7

| | BEFORE ERASER | | AFTER ERASER | | | |
|---|---|---|---|---|---|---|
| | ABRASION | | ABRASION | | | |
| | % | | % | | Δ (AFTER-BEFORE) | |
| | Transmission | % Haze | Transmission | % Haze | Δ % | Δ % |
| EXAMPLE | (Std Dev) | (Std Dev) | (Std Dev) | (Std Dev) | Transmission | Haze |
| COMPARATIVE | 91.3 | 0.22 | 92.3 | 3.00 | 1.0 | 2.78 |
| EXAMPLE D1 | (0.06) | (0.07) | (0.00) | (0.29) | | |
| COMPARATIVE | 91.1 | 0.43 | 92.1 | 3.18 | 1.0 | 2.75 |
| EXAMPLE D2 | (0.10) | (0.03) | (0.10) | (0.04) | | |
| COMPARATIVE | 90.9 | 0.79 | 92.0 | 3.31 | 1.1 | 2.52 |
| EXAMPLE D3 | (0.00) | (0.12) | (0.10) | (0.11) | | |
| COMPARATIVE | 91.1 | 0.51 | 92.0 | 3.35 | 0.9 | 2.84 |
| EXAMPLE E1 | (0.06) | (0.00) | (0.06) | (0.05) | | |
| COMPARATIVE | 90.9 | 0.74 | 91.9 | 3.45 | 1.0 | 2.71 |
| EXAMPLE E2 | (0.06) | (0.06) | (0.06) | (0.12) | | |
| COMPARATIVE | 91.3 | 0.45 | 91.9 | 3.13 | 0.6 | 2.68 |
| EXAMPLE F1 | (0.00) | (0.07) | (0.15) | (0.17) | | |
| COMPARATIVE | 91.1 | 0.62 | 91.8 | 2.87 | 0.7 | 2.25 |
| EXAMPLE F2 | (0.06) | (0.07) | (0.06) | (0.14) | | |
| COMPARATIVE | 91.4 | 0.49 | 92.0 | 3.08 | 0.6 | 2.59 |
| EXAMPLE G1 | (0.00) | (0.05) | (0.06) | (0.27) | | |
| COMPARATIVE | 91.3 | 0.82 | 91.8 | 2.45 | 0.5 | 1.63 |
| EXAMPLE G2 | (0.06) | (0.08) | (0.06) | (0.18) | | |
| 1 | 91.4 | 0.43 | 92.0 | 1.36 | 0.6 | 0.93 |
| | (0.06) | (0.02) | (0.06) | (0.19) | | |
| 2 | 91.3 | 0.72 | 91.8 | 1.95 | 0.5 | 1.23 |
| | (0.06) | (0.00) | (0.00) | (0.24) | | |
| COMPARATIVE | 91.5 | 0.53 | 91.9 | 2.38 | 0.4 | 1.85 |
| EXAMPLE H1 | (0.10) | (0.04) | (0.06) | (0.11) | | |
| COMPARATIVE | 91.3 | 0.62 | 91.8 | 2.27 | 0.5 | 1.65 |
| EXAMPLE H2 | (0.00) | (0.03) | (0.06) | (0.04) | | |
| COMPARATIVE | 91.5 | 0.28 | 92.0 | 2.37 | 0.5 | 2.09 |
| EXAMPLE I1 | (0.06) | (0.05) | (0.00) | (0.13) | | |
| COMPARATIVE | 91.4 | 0.75 | 91.9 | 2.37 | 0.5 | 1.62 |
| EXAMPLE I2 | (0.06) | (0.10) | (0.06) | (0.14) | | |
| COMPARATIVE | 91.7 | 0.39 | 91.8 | 3.02 | 0.1 | 2.63 |
| EXAMPLE J1 | (0.00) | (0.03) | (0.06) | (0.12) | | |
| COMPARATIVE | 91.4 | 0.81 | 91.8 | 3.47 | 0.4 | 2.66 |
| EXAMPLE J2 | (0.12) | (0.13) | (0.06) | (0.40) | | |
| COMPARATIVE | 91.7 | 0.46 | 91.8 | 2.97 | 0.1 | 2.51 |
| EXAMPLE K1 | (0.06) | (0.05) | (0.06) | (0.13) | | |
| COMPARATIVE | 91.5 | 0.79 | 91.5 | 3.56 | 0.0 | 2.77 |
| EXAMPLE K2 | (0.06) | (0.04) | (0.00) | (0.27) | | |

### Examples 3 -8 and Comparative Examples L-N

In the following examples, the alpha-alumina nanoparticle dispersion (AANP1) and HEA-SA solution were added to Master Formulation A along with SR611 in one step. Comparative Example L contains neither alpha-alumina nanoparticles nor HEA-SA. Examples 3-10 contained surface-modifying agent and alpha-alumina nanoparticles.

The example compositions containing surface-modified alpha-alumina nanoparticles are reported in Table 8. The formulations were hand-coated on PC film using a #12 wire-wound rod (RD Specialties, Webster, N.Y., 0.30 mm wire size). The coated PC films were allowed to dry at room temperature first and then dried at 80° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). In Table 8 (below), all examples contained 4.50 g of Master Formulation A and 0.25 g of SR611 (32 wt. % in ethanol), and they had a total solids content of 32.1 percent.

TABLE 8

| | | HEA-SA, | | α-ALUMINA | HEA-SA |
|---|---|---|---|---|---|
| | | g (32 wt. | ETHA- | WT. % OF | wt. % of |
| | AANP1 | % in | NOL, | TOTAL | Total |
| EXAMPLE | g | ethanol) | g | SOLIDS | Solids |
| COM- | 0.000 | 0.000 | 0.00 | 0.0 | 0.0 |
| PARATIVE | | | | | |
| EXAMPLE L | | | | | |
| COM- | 0.000 | 0.004 | 0.00 | 0.0 | 0.1 |
| PARATIVE | | | | | |
| EXAMPLE M | | | | | |
| COM- | 0.071 | 0.000 | 0.05 | 1.2 | 0.0 |
| PARATIVE | | | | | |
| EXAMPLE N | | | | | |
| 3 | 0.071 | 0.004 | 0.05 | 1.2 | 0.1 |
| 4 | 0.072 | 0.008 | 0.05 | 1.2 | 0.2 |
| 5 | 0.072 | 0.020 | 0.05 | 1.2 | 0.4 |
| 6 | 0.072 | 0.060 | 0.05 | 1.2 | 1.2 |
| 7 | 0.075 | 0.120 | 0.05 | 1.3 | 2.4 |
| 8 | 0.075 | 0.250 | 0.05 | 1.2 | 4.9 |

The transmission and haze before and after eraser abrasion test are reported in Table 9, below.

TABLE 9

| | BEFORE ERASER | | AFTER ERASER | | | |
|---|---|---|---|---|---|---|
| | ABRASION | | ABRASION | | | |
| | % | | % | | Δ (After-Before) | |
| | Transmission | % Haze | Transmission | % Haze | Δ % | Δ % |
| EXAMPLE | (Std Dev) | (Std Dev) | (Std Dev) | (Std Dev) | Transmission | Haze |
| COMPARATIVE | 91.0 | 0.36 | 91.0 | 3.26 | 0.0 | 2.90 |
| EXAMPLE L | (0.06) | (0.03) | (0.06) | (0.17) | | |
| COMPARATIVE | 91.0 | 0.40 | 91.4 | 3.32 | 0.4 | 2.92 |
| EXAMPLE M | (0.06) | (0.11) | (0.10) | (0.03) | | |
| COMPARATIVE | 91.4 | 0.46 | 91.5 | 2.97 | 0.1 | 2.51 |
| EXAMPLE N | (0.06) | (0.07) | (0.06) | (0.22) | | |
| 3 | 91.3 | 0.52 | 91.6 | 3.21 | 0.3 | 2.69 |
| | (0.10) | (0.05) | (0.06) | (0.12) | | |
| 4 | 91.7 | 0.47 | 91.7 | 3.10 | 0.0 | 2.63 |
| | (0.06) | (0.12) | (0.06) | (0.19) | | |
| 5 | 91.8 | 0.50 | 91.8 | 2.75 | 0.0 | 2.25 |
| | (0.00) | (0.15) | (0.06) | (0.21) | | |
| 6 | 91.9 | 0.44 | 91.8 | 2.43 | −0.1 | 1.99 |
| | (0.06) | (0.05) | (0.12) | (0.22) | | |
| 7 | 92.0 | 0.45 | 91.9 | 2.60 | −0.1 | 2.15 |
| | (0.00) | (0.03) | (0.06) | (0.29) | | |
| 8 | 91.8 | 0.45 | 92.1 | 2.73 | 0.3 | 2.28 |
| | (0.06) | (0.00) | (0.06) | (0.15) | | |

### Examples 9-14 and Comparative Examples O-Q

In the following examples, the alpha-alumina nanoparticle dispersion (AANP1) and HEA-SA solution were added to Master Formulation A along with SR611 in a single step. Comparative Example 0 contained neither alpha-alumina nanoparticles nor HEA-SA.

The formulations were hand-coated on PC film using a #12 wire-wound rod (RD Specialties, Webster, N.Y., 0.30 mm wire size). The coated PC films were allowed to dry at room temperature first and then dried at 80 ° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). Results are reported in Table 10 (below). All examples contained 4.50 g of Master Formulation A and 0.25 g of SR611 (32 wt. % in ethanol), and they had a total solids content of 32.1 percent.

TABLE 10

| | | HEA-SA, | | α-ALUMINA | HEA-SA |
|---|---|---|---|---|---|
| | | g (32 wt. | ETHA- | WT. % OF | wt. % of |
| | AANP1, | % in | NOL, | TOTAL | Total |
| EXAMPLE | g | ethanol) | g | SOLIDS | Solids |
| COM- | 0.000 | 0.000 | 0.00 | 0.00 | 0.00 |
| PARATIVE | | | | | |
| EXAMPLE O | | | | | |
| COM- | 0.000 | 0.086 | 0.00 | 0.00 | 1.77 |
| PARATIVE | | | | | |
| EXAMPLE P | | | | | |
| COM- | 0.110 | 0.000 | 0.07 | 1.88 | 0.00 |
| PARATIVE | | | | | |
| EXAMPLE Q | | | | | |
| 9 | 0.110 | 0.006 | 0.07 | 1.87 | 0.10 |
| 10 | 0.110 | 0.012 | 0.07 | 1.87 | 0.24 |
| 11 | 0.111 | 0.029 | 0.07 | 1.88 | 0.58 |
| 12 | 0.112 | 0.089 | 0.07 | 1.87 | 1.77 |
| 13 | 0.114 | 0.172 | 0.07 | 1.88 | 3.35 |
| 14 | 0.118 | 0.350 | 0.08 | 1.87 | 6.59 |

The transmission and haze before and after eraser abrasion test are reported in Table 11, below.

TABLE 11

| | BEFORE ERASER | | AFTER ERASER | | | |
|---|---|---|---|---|---|---|
| | ABRASION | | ABRASION | | | |
| | % | | % | | Δ (After-Before) | |
| | Transmission | % Haze | Transmission | % Haze | Δ % | Δ % |
| EXAMPLE | (Std Dev) | (Std Dev) | (Std Dev) | (Std Dev) | Transmission | Haze |
| COMPARATIVE | 91.1 | 0.29 | 91.1 | 1.57 | 0.0 | 1.28 |
| EXAMPLE O | (0.00) | (0.09) | (0.06) | (0.31) | | |
| COMPARATIVE | 91.2 | 0.25 | 91.1 | 2.13 | −0.1 | 1.88 |
| EXAMPLE P | (0.06) | (0.07) | (0.00) | (0.35) | | |
| COMPARATIVE | 90.9 | 0.26 | 90.9 | 0.94 | 0.0 | 0.68 |
| EXAMPLE Q | (0.00) | (0.19) | (0.06) | (0.11) | | |
| 9 | 90.9 | 0.54 | 91.0 | 0.90 | 0.1 | 0.36 |
| | (0.06) | (0.00) | (0.06) | (0.10) | | |
| 10 | 91.0 | 0.82 | 91.2 | 0.83 | 0.2 | 0.01 |
| | (0.15) | (0.04) | (0.06) | (0.00) | | |
| 11 | 91.1 | 0.68 | 91.1 | 1.23 | 0.0 | 0.55 |
| | (0.06) | (0.09) | (0.07) | (0.00) | | |
| 12 | 91.1 | 0.63 | 91.3 | 1.12 | 0.2 | 0.49 |
| | (0.06) | (0.08) | (0.06) | (0.15) | | |
| 13 | 91.1 | 0.83 | 91.2 | 5.37 | 0.1 | 4.54 |
| | (0.06) | (0.03) | (0.00) | (0.58) | | |
| 14 | 91.3 | 0.74 | 91.3 | 3.93 | 0.0 | 3.19 |
| | (0.06) | (0.18) | (0.06) | (0.34) | | |

### Examples 15-20 and Comparative Examples R-T

In the following examples, the alpha-alumina nanoparticle dispersion and HEA-SA solution were added to Master Formulation A along with SR611 in one step. Comparative Example R contained neither alpha-alumina nanoparticles nor HEA-SA.

The coating formulations containing surface modified alpha-alumina nanoparticles are reported in Table 12. The examples were hand-coated on PC film using a #12 wire-wound rod (RD Specialties,

Webster, N.Y., 0.30 mm wire size). The coated PC films were allowed to dry at room temperature first and then dried at 80 ° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). In Table 12 (below), all examples contained 4.50 g of Master Formulation A and 0.25 g of SR611 (32 wt. % in ethanol), and they had a total solids content of 32.1 percent.

TABLE 12

| | | HEA-SA, | | α-ALUMINA | HEA-SA |
|---|---|---|---|---|---|
| | | g (32 wt. | ETHA- | WT. % OF | WT. % OF |
| | AANP1, | % in | NOL, | TOTAL | TOTAL |
| EXAMPLE | g | ethanol) | g | SOLIDS | SOLIDS |
| COM- | 0.000 | 0.000 | 0.00 | 0.0 | 0.0 |
| PARATIVE | | | | | |
| EXAMPLE R | | | | | |
| COM- | 0.000 | 0.110 | 0.00 | 0.0 | 2.3 |
| PARATIVE | | | | | |
| EXAMPLE S | | | | | |
| COM- | 0.150 | 0.000 | 0.10 | 2.5 | 0.0 |
| PARATIVE | | | | | |
| EXAMPLE T | | | | | |
| 15 | 0.150 | 0.008 | 0.10 | 2.5 | 0.2 |
| 16 | 0.150 | 0.016 | 0.10 | 2.5 | 0.3 |
| 17 | 0.150 | 0.040 | 0.10 | 2.5 | 0.8 |
| 18 | 0.152 | 0.120 | 0.10 | 2.5 | 2.3 |
| 19 | 0.155 | 0.240 | 0.10 | 2.5 | 4.6 |
| 20 | 0.163 | 0.500 | 0.11 | 2.5 | 9.0 |

The transmission and haze before and after eraser abrasion test are reported in Table 13, below.

TABLE 13

| | BEFORE ERASER | | AFTER ERASER | | | |
|---|---|---|---|---|---|---|
| | ABRASION | | ABRASION | | | |
| | % | | % | | Δ (After-Before) | |
| | Transmission | % Haze | Transmission | % Haze | Δ % | Δ % |
| EXAMPLE | (Std Dev) | (Std Dev) | (Std Dev) | (Std Dev) | Transmission | Haze |
| COMPARATIVE | 91.7 | 0.24 | 91.3 | 2.73 | −0.4 | 2.49 |
| EXAMPLE R | (0.06) | (0.00) | (0.00) | (0.31) | | |
| COMPARATIVE | 91.7 | 0.31 | 91.4 | 2.20 | −0.3 | 1.89 |
| EXAMPLE S | (0.00) | (0.15) | (0.06) | (0.21) | | |
| COMPARATIVE | 91.1 | 1.27 | 91.2 | 3.37 | 0.1 | 2.10 |
| EXAMPLE T | (0.00) | (0.14) | (0.00) | (0.28) | | |
| 15 | 91.4 | 0.95 | 91.3 | 2.95 | −0.1 | 2.00 |
| | (0.05) | (0.19) | (0.00) | (0.16) | | |
| 16 | 91.4 | 1.32 | 91.3 | 1.81 | −0.1 | 0.49 |
| | (0.06) | (0.12) | (0.06) | (0.11) | | |
| 17 | 91.5 | 1.19 | 91.4 | 1.37 | −0.1 | 0.18 |
| | (0.00) | (0.04) | (0.06) | (0.00) | | |
| 18 | 91.5 | 1.09 | 91.4 | 1.47 | −0.1 | 0.38 |
| | (0.05) | (0.22) | (0.06) | (0.08) | | |
| 19 | 91.5 | 1.03 | 91.5 | 1.31 | 0.0 | 0.28 |
| | (0.06) | (0.16) | (0.06) | (0.00) | | |
| 20 | 91.5 | 1.01 | 91.4 | 1.48 | −0.1 | 0.47 |
| | (0.00) | (0.14) | (0.06) | (0.07) | | |

### Examples 21-24

AANP2 was used to make the following formulations (Table 14). The formulations were hand-coated on PC film using a #12 wire-wound rod (RD Specialties, 0.30 mm wire size). The coated PC films were allowed to dry at room temperature first and then dried at 80 ° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). In Table 14 (below), all examples contained 4.50 g of Master Formulation A and 0.25 g of SR611 (32 wt. % in ethanol), and they had a total solids content of 32.1 percent.

TABLE 14

| | | HEA-SA, | | α-ALUMINA | HEA-SA |
|---|---|---|---|---|---|
| | | g (32 wt. | ETHA- | WT. % OF | WT. % OF |
| | AANP2, | % in | NOL, | TOTAL | TOTAL |
| EXAMPLE | g | ethanol) | g | SOLIDS | SOLIDS |
| 21 | 0.050 | 0.019 | 0.02 | 1.2 | 0.39 |
| 22 | 0.051 | 0.056 | 0.02 | 1.2 | 1.15 |
| 23 | 0.051 | 0.110 | 0.02 | 1.2 | 2.23 |
| 24 | 0.052 | 0.230 | 0.02 | 1.2 | 4.55 |

The transmission and haze before and after eraser abrasion test are reported in Table 15, below.

TABLE 15

| | BEFORE ERASER | | AFTER ERASER | | | |
|---|---|---|---|---|---|---|
| | ABRASION | | ABRASION | | | |
| | % | | % | | Δ (After-Before) | |
| | Transmission | % Haze | Transmission | % Haze | Δ % | Δ % |
| EXAMPLE | (Std Dev) | (Std Dev) | (Std Dev) | (Std Dev) | Transmission | Haze |
| 21 | 91.1 | 0.34 | 91.0 | 0.94 | −0.1 | 0.60 |
| | (0.00) | (0.00) | (0.06) | (0.26) | | |
| 22 | 91.1 | 0.35 | 91.0 | 0.48 | −0.1 | 0.13 |
| | (0.12) | (0.06) | (0.00) | (0.10) | | |
| 23 | 91.1 | 0.32 | 91.1 | 0.37 | 0.0 | 0.05 |
| | (0.06) | (0.05) | (0.00) | (0.03) | | |
| 24 | 91.1 | 0.42 | 91.1 | 0.58 | 0.0 | 0.16 |
| | (0.06) | (0.11) | (0.00) | (0.15) | | |

### Examples 25-28

AANP2 was used to make the following formulations (Table 16). The formulations were hand-coated on PC film using a #12 wire-wound rod (RD Specialties, 0.30 mm wire size). The coated PC films were allowed to dry at room temperature first and then dried at 80 ° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). In Table 16 (below), all examples contained 4.50 g of Master Formulation A and 0.25 g of SR611 (32 wt. % in ethanol), and they had a total solids content of 31.8 percent.

TABLE 16

| | | HEA-SA, | | α-ALUMINA | HEA-SA |
|---|---|---|---|---|---|
| | | g (32 wt. | ETHA- | WT. % OF | WT. % OF |
| | AANP2, | % in | NOL, | TOTAL | TOTAL |
| EXAMPLE | g | ethanol) | g | SOLIDS | SOLIDS |
| 25 | 0.082 | 0.006 | 0.07 | 1.88 | 0.12 |
| 26 | 0.082 | 0.012 | 0.07 | 1.88 | 0.25 |
| 27 | 0.082 | 0.029 | 0.07 | 1.87 | 0.59 |
| 28 | 0.083 | 0.089 | 0.07 | 1.87 | 1.80 |

The transmission and haze before and after eraser abrasion test are reported in Table 17, below.

TABLE 17

| | BEFORE ERASER | | AFTER ERASER | | | |
|---|---|---|---|---|---|---|
| | ABRASION | | ABRASION | | | |
| | % | | % | | Δ (After-Before) | |
| | Transmission | % Haze | Transmission | % Haze | Δ % | Δ % |
| EXAMPLE | (Std Dev) | (Std Dev) | (Std Dev) | (Std Dev) | Transmission | Haze |
| 25 | 91.1 | 0.48 | 91.0 | 1.29 | −0.1 | 0.81 |
| | (0.00) | (0.06) | (0.00) | (0.28) | | |
| 26 | 91.1 | 0.43 | 91.0 | 0.87 | −0.1 | 0.44 |
| | (0.00) | (0.00) | (0.06) | (0.16) | | |
| 27 | 91.1 | 0.50 | 91.0 | 0.72 | −0.1 | 0.22 |
| | (0.00) | (0.04) | (0.06) | (0.00) | | |
| 28 | 91.1 | 0.63 | 91.0 | 1.08 | −0.1 | 0.45 |
| | (0.06) | (0.13) | (0.00) | (0.28) | | |

### Examples 29-32

AANP2 was used to make the following formulations (Table 18). The formulations were hand-coated on PC film using a #12 wire-wound rod (RD Specialties, 0.30 mm wire size). The coated PC films were allowed to dry at room temperature first and then dried at 80° C. in an oven for 1 min. The dried samples were cured using a UV processor equipped with an H-type bulb (500 W, Heraeus Noblelight America/Fusion UV Systems, Gaithersburg, Md.) at 100% power under nitrogen purge at 30 feet/min (9.1 m/min). In Table 18 (below), all examples contained 4.50 g of Master Formulation A and 0.25 g of SR611 (32 wt. % in ethanol), and they had a total solids content of 32.1 percent.

TABLE 18

| | | HEA-SA, | | α-ALUMINA | HEA-SA |
|---|---|---|---|---|---|
| | | g (32 wt. | ETHA- | WT. % OF | WT. % OF |
| | AANP2, | in % | NOL, | TOTAL | TOTAL |
| EXAMPLE | g | ethanol) | g | SOLIDS | SOLIDS |
| 29 | 0.110 | 0.017 | 0.05 | 2.5 | 0.3 |
| 30 | 0.110 | 0.040 | 0.05 | 2.5 | 0.8 |
| 31 | 0.113 | 0.120 | 0.05 | 2.5 | 2.4 |
| 32 | 0.113 | 0.230 | 0.05 | 2.5 | 4.5 |

The transmission and haze before and after eraser abrasion test are reported in Table 19, below.

TABLE 19

| | BEFORE ERASER | | AFTER ERASER | | | |
|---|---|---|---|---|---|---|
| | ABRASION | | ABRASION | | | |
| | % | | % | | Δ (After-Before) | |
| | Transmission | % Haze | Transmission | % Haze | Δ % | Δ % |
| EXAMPLE | (Std Dev) | (Std Dev) | (Std Dev) | (Std Dev) | Transmission | Haze |
| 29 | 90.9 | 0.63 | 91.0 | 1.10 | 0.1 | 0.47 |
| | (0.06) | (0.10) | (0.05) | (0.53) | | |
| 30 | 91.0 | 0.60 | 90.9 | 2.01 | −0.1 | 1.41 |
| | (0.00) | (0.09) | (0.06) | (0.41) | | |
| 31 | 90.9 | 0.67 | 90.9 | 1.05 | 0.0 | 0.38 |
| | (0.00) | (0.00) | (0.06) | (0.26) | | |
| 32 | 91.0 | 0.66 | 90.9 | 1.52 | −0.1 | 0.86 |
| | (0.00) | (0.10) | (0.00) | (0.75) | | |

All cited references, patents, and patent applications in this application that are incorporated by reference, are incorporated in a consistent manner. In the event of inconsistencies or contradictions between portions of the incorporated references and this application, the information in this application shall control. The preceding description, given in order to enable one of ordinary skill in the art to practice the claimed disclosure, is not to be construed as limiting the scope of the disclosure, which is defined by the claims and all equivalents thereto.

What is claimed is:

1. A curable composition comprising components:
a) alpha-alumina particles;
b) 4-(2-(acryloyloxy)ethoxy)-4-oxobutanoic acid;
c) at least one free-radically polymerizable compound different from component b); and
d) optionally an effective amount of free-radical initiator.

2. The curable composition of claim 1, wherein the at least one free-radically polymerizable compound comprises at least one (meth)acrylic monomer.

3. The curable composition of claim 1, wherein the alpha-alumina particles have a volume average particle diameter of less than or equal to 100 nanometers.

4. The curable composition of claim 1, wherein the alpha-alumina particles have a volume average particle diameter of greater than 100 nanometers.

5. The curable composition of claim 1, wherein the alpha-alumina particles comprise 2 to 20 percent by weight, based on the total weight of components a) to c).

6. An at least partially cured reaction product of components comprising:
a) alpha-alumina particles;
b) 4-(2-(acryloyloxy)ethoxy)-4-oxobutanoic acid;
c) at least one free-radically polymerizable compound different from component b); and
d) optionally an effective amount of free-radical initiator.

7. The cured reaction product of claim 6, wherein the at least one free-radically polymerizable compound comprises at least one (meth)acrylic monomer.

8. The cured reaction product of claim 6, wherein the alpha-alumina particles have a volume average particle diameter of less than or equal to 100 nanometers.

9. The cured reaction product of claim 6, wherein the alpha-alumina particles have a volume average particle diameter of greater than 100 nanometers.

10. The cured reaction product of claim 6, wherein the alpha-alumina particles comprise from 2 to 20 percent by weight, based on the total weight of components a) to c).

11. An abrasion-resistant article comprising:
a substrate having a protective layer disposed on at least a portion thereof, wherein the protective layer comprises a reaction product of components comprising:
a) alpha-alumina particles;
b) 4-(2-(acryloyloxy)ethoxy)-4-oxobutanoic acid;
c) at least one free-radically polymerizable compound different from component b); and
d) optionally an effective amount of free-radical initiator.

12. The abrasion-resistant article of claim 11, wherein the at least one free-radically polymerizable compound comprises at least one (meth)acrylic monomer.

13. The abrasion-resistant article of claim 11, wherein the alpha-alumina particles have a volume average particle diameter of less than or equal to 100 nanometers.

14. The abrasion-resistant article of claim 11, wherein the alpha-alumina particles have a volume average particle diameter of greater than 100 nanometers.

15. The abrasion-resistant article of claim 11, wherein the alpha-alumina particles comprise 2 to 20 percent by weight, based on the total weight of components a) to c).
